(19) United States
(12) Patent Application Publication
(10) Pub. No.: US 2004/0132631 A1
(43) Pub. Date: Jul. 8, 2004

(54) Blowing agent blends

(75) Inventors: Steve M. Galaton, Doylestown, PA (US); Christopher Bertelo, Doylestown, PA (US)

Correspondence Address: ATOFINA CHEMICALS INC., PATENT DEPARTMENT - 26TH FLOOR, 2000 MARKET STREET, PHILADELPHIA, PA, 19103-3222, US

(73) Assignee: ATOFINA Chemicals, Inc.

(21) Appl. No.: 10/336,368

(22) Filed: Jan. 2, 2003

(51) Int. Cl. C11D 17/00

(52) U.S. Cl. 510/407

(57) ABSTRACT

Foam blowing agent blends containing trans-1,2-dichloroethylene and one or more hydrofluorocarbons are provided, as are foam compositions containing such blends. The resulting foams exhibit dramatic improvement in fire performance.

### BACKGROUND OF THE INVENTION

This invention relates to foam blowing agent blends containing trans-1,2-dichloroethylene (“Trans 12”) and one or more hydrofluorocarbons (“HFCs”), and to foam compositions containing such blends. Trans 12 is useful to improve the fire performance (that is, to suppress flame spread and smoke generation) of HFC-blown, closed cell polymer (insulation) foams, such as polystyrene, phenolic and polyurethane foams.

Chlorofluorocarbons (“CFCs”) had been used as blowing agents for rigid, closed cell insulation foams for many years because they offer outstanding fire resistance in addition to good thermal insulation, since the CFCs are non-flammable. However, CFCs have been phased out because they are said to be detrimental to the ozone layer. Hydrofluorocarbons (“HCFCs”) such as 1,1-dichloro-1-fluoroethane (“HCFC-141b”) with low ozone depletion potential (“ODP”) have been alternatives for CFCs. However, HCFCs are also being phased out under the Montreal Protocol. The next generation of foam blowing agents must have zero ODP. For fluorochemical blowing agents, these are generally the HFCs such as 1,1,1,3,3-pentafluorobutane (“HFC-365mfc”). However, HFCs are typically more flammable than the CFCs or HCFCs, so that the new formulations will usually require higher levels of flame retardants in order to achieve the same levels of flammability. This increased level of flame retardant creates a problem because upon burning the flame retardants increase smoke levels. Thus, as disclosed by Albemarle Corporation in its website, Albemarle.com/saytexfr_polyurethane.htm, the addition of a brominated reactive polyol (RB-79) increases the smoke density of foam when subjected to fire tests. It has been reported that the use of 245fa alone will result in foams which generate high smoke density. What is thus needed is a means to achieve satisfactory blowing with HFCs while reducing the amount of fire retardant so as to reduce smoke density and lower overall cost. While Trans 12 has been disclosed as a foam blowing agent, as for example in U.S. Pat. No. 5,126,067, its use to reduce flame spread or smoke density has not been previously disclosed.

### BRIEF SUMMARY OF THE INVENTION

An HFC-based foam blowing agent composition is provided, which composition contains Trans 12 in an amount effective to enhance the fire performance of the blown foam, as well as polyurethane foam compositions comprising a polyol, an isocyanate and the blowing agent composition. Preferred HFCs include HFC-365mfc, 1,1,1,3,3-pentafluoro-propane (“HFC-245fa”) and 1,1,1,2-tetrafluoroethane (“134a”). Typical Trans 12 levels are from about 5 to 40% by weight, based on the total blowing agent weight.

### DETAILED DESCRIPTION

Trans 12 improves the fire performance (suppresses flame spread and smoke generation) of HFC blown foams, as well as lowering the global warming potential of the blends compared to HFC alone and lowering the overall cost of the foam formulation by reducing the amount of required flame retardant. As noted above, these blends are particularly useful for making closed cell polymer (insulation) foams having improved fire performance, such as polystyrene, phenolic and polyurethane foams.

Trans 12 generally makes up 5-40 weight % of the blends. In the polyurethane foam compositions, the effective concentrations of the blends are typically about 0.1-25 weight % (preferably 0.5-15 weight %), based on the weight of the total polyurethane foam formulation.

The blowing agent can be distributed between the “A” and “B” sides of the foam composition. All or a portion of it can also be added at the time of injection. The Trans 12/HFC blends can also contain additional blowing agents such as water or pentane(s).

The other components of the premix and foam formulations may be those which are conventionally used, which components and their proportions are well known to those skilled in the art. For example, fire retardants, surfactants and polyol are typical components of the B-side, while the A-side is primarily comprised of polyisocyanate. Water is frequently used as a coblowing agent. The A and B sides are typically mixed together, followed by injection of the catalyst, after which the mixture is poured into a mold or box.

We claim:

1. A hydrofluorocarbon-based foam blowing agent composition containing trans-1,2-dichloroethylene in an amount effective to enhance the fire performance of the blown foam.

2. The blowing agent composition of claim 1 wherein the hydrofluorocarbon is 1,1,1,3,3-pentafluoropropane.

3. The blowing agent composition of claim 1 wherein the hydrofluorocarbon is 1,1,1,3,3-pentafluorobutane.

4. The blowing agent composition of claim 1 wherein the hydrofluorocarbon is 1,1,1,2-tetrafluoroethane.

5. A polyurethane foam composition comprising an isocyanate, a polyol and the foam blowing agent composition of claim 1.

6. The polyurethane foam composition of claim 5 wherein the hydrofluorocarbon is 1,1,1,3,3-pentafluoropropane.

7. The polyurethane foam composition of claim 5 wherein the hydrofluorocarbon is 1,1,1,3,3-pentafluorobutane.

8. The polyurethane foam composition of claim 5 wherein the hydrofluorocarbon is 1,1,1,2-tetrafluoroethane.
